(19) United States
(12) Patent Application Publication
(10) Pub. No.: US 2010/0094839 A1
(43) Pub. Date: Apr. 15, 2010

(54) Coordinated notification

(76) Inventor: Ricci S. Brach, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 12/285,742

(22) Filed: Oct. 14, 2008

(51) Int. Cl. G06F 17/30; G06F 7/06; G06F 15/16

(52) U.S. Cl. 707/705; 709/206; 707/E17.014; 707/E17.005

(57) ABSTRACT

A method for providing coordinated notification comprises storing a plurality of service profiles in a network-accessible repository. Each profile includes data relating to a service, a user, and data relating to identifying the user by the provider of the service. When a notification request relating to a change of status of a first user is received via the network, a subset of the plurality of service profiles is determined, each profile of the subset comprising data that are affected by the change of status of the first user. Based on each profile of the subset of profiles, contact data is extracted defining a mode of delivery for providing a notification message to a service provider that is associated with that profile, and address information for directing delivery of the notification message to the service provider via the mode of delivery.

### FIELD OF THE INVENTION

The invention relates generally to providing personal information databases, and more particularly to providing coordinated notification of events affecting multiple organizations referenced within the database.

### BACKGROUND OF THE INVENTION

With the ubiquity of public computer networks, commonly known as the Internet or World Wide Web (the “Web”), new ways of disseminating personal information and conducting many aspects of an individual's life become possible. The meteoric rise of the Internet, coupled with the availability of advanced applications with simple graphical user interfaces, pull-down menus, and detailed help facilities (both within an application and online), have allowed it to become a key application for businesses, charities, financial institutions, service providers and individuals for managing financial and personal records.

Despite this, even when an individual has actually registered all normal aspects of their daily life online with their service providers, they are typically accessing their information on a discrete basis, namely logging into each service provider account separately. In some instances, such as registering with the US Postal Service or Canada Post, the user may centralize a portion of their service providers in respect to the receipt and payment of bills. However, many aspects of their personal information are either not captured in electronic form, though they are readily accessible to the user, or they are documented in electronic and other formats, but are not readily accessible to the user.

At specific instances in the lifetime of an individual, different events occur requiring them to retrieve and either utilize or amend a specific aspect of their personal information or their engagement with the service providers. Consider for example the common occurrence of an individual loosing their wallet or purse. The result is an immediate, short-term requirement to contact several financial institutions and cancel aspects of their financial activities, such as credit cards and debit cards, whilst triggering replacements. There is also a subsequent requirement over a relatively short period of time to perform similar actions with a potentially large number of service providers. At present the user must contact each of several service provider individually and follow their specific procedures. Unfortunately, the user may not have all of the required information, including account numbers, authorization codes etc., readily available to complete these activities, for example due to geographic displacement from their place of residence or due to the fact that some of the relevant information is printed on the items that have been lost.

Equally, consider the relatively infrequent event of moving. Table 1 below lists some of the most common service providers for an individual or family residing in the United States, each service provider requiring notification and liaison in the case of moving. Of course, the list that is presented in Table 1 is not exhaustive, and it varies dramatically according to the particular individual or family. Furthermore, even a single item within the list, for example “Bank” or “Pension,” may necessitate an individual contacting multiple financial institutions or multiple divisions of the same financial institution.
United States Postal Service
Internal Revenue Service
State Vehicle Registration
State Registrations—Hunting/Fishing/Boat/Snowmobile
Banks—Checking/Deposit/Investment/Loan etc.
Mortgage Providers/Credit Agencies/Credit Unions/Paypal®
Residential/City/Municipality Tax
Online Retailers/eBay®
Non-Bank Credit Card Issuers
Store Charge Accounts
Insurance Companies—House/Car/Life/Supplemental
Health Insurance Company
Subscriptions—Newspaper/Magazine
Clubs—Netflix/Record/Book-of-the-Month
Pension Plan/401K
Social Security
Medicaid
Veterans Office
Electrical Utility
Gas/Fuel Oil Company
Water Service
Telephone—Local/Long-Distance/VOIP
Cellular Phone
Long Distance Telephone/Phone Calling Cards
Cable/Satellite Dish Service Provider
Internet Service Provider
Library
Doctors
Schools/Colleges/University
Vehicle Recovery Service
Employer
Dentist/Orthodontist
Ophthalmetrist
Financial Advisor
Lawyer
Maid Service/Landscaping/Plowing
Clubs/Service Organizations/Museums
Friends
Relatives

### Table 1: Typical Contact List for Home Owner Moving House

In some instances, for example an individual owning a second property such as a vacation home, it is likely that a significant portion of the above list is duplicated for the vacation home, but with reference their current home address for contact and notification purposes, therefore also requiring notification when the individual moves. Overall, the result is that the individual has a very large number of contacts that require continued updates in respect of specific aspects of the individual's personal information.

Known solutions for managing online personal information tend to focus on ensuring that the information is secure, and that it is communicated only upon specific instructions of the individual or of an authorized requesting party providing the appropriate credentials of the individual, such as for example providing account related information and a personal password. As such, there is no associative cross-referencing, or relationships applied between elements. Hence, current online personal information managers partition the account information for security, rather than associating and cross-referencing information to support activities of the individual.

It would be beneficial to provide a method and system that overcomes at least some of the above-mentioned limitations.

### SUMMARY OF THE INVENTION

According to an aspect of the invention there is provided a method comprising: storing a plurality of service profiles in a network-accessible repository, each profile of the plurality of service profiles including data relating to a service, a user, and data relating to identifying the user by said provider of the service; receiving via the network a notification request relating to a change of status of a first user; determining a subset of the plurality of service profiles, each profile of the subset of profiles comprising data that are affected by the change of status of the first user; and, extracting, based on each profile of the subset of profiles, contact data defining at least a mode of delivery for providing a notification message to a service provider that is associated with that profile and address information for directing delivery of the notification message to the service provider via the mode of delivery.

According to an aspect of the invention, there is provided a method comprising: storing a plurality of service profiles in a network-accessible repository, each profile of the plurality of service profiles including data relating to a service, a user, and data relating to identifying the user by said provider of the service; receiving via the network an indication relating to a change of status of a first user and including data for identifying service profiles comprising data that are affected by the change of status of the first user; based on the data included with the indication, identifying a plurality of service profiles containing data that are affected by the change of status of the first user, including a first profile that is associated with a first service provider and a second profile that is associated with a second service provider; and, extracting, based on the first and second service profiles, contact data for use in providing notification messages to the first service provider and to the second service provider, respectively, the notification messages relating to the change of status of the first user.

According to an aspect of the invention there is provided a system comprising: a storage medium for retrievably storing a plurality of service profiles, each profile of the plurality of service profiles including data relating to a service, a user, and data relating to identifying the user by said provider of the service; and, a user interface, implemented in software that is installed on an electronic device, in network communication with the storage medium, for receiving an indication relating to a change of status of a first user, and for identifying at least two service profiles of the plurality of service profiles that contain data that is affected by the change of status of the first user, and for coordinating notification activities for notifying at least two different service providers that data contained in a service profile relating thereto is affected by the change of status of the first user.

### BRIEF DESCRIPTION OF THE DRAWINGS

Embodiments of the invention will now be described in conjunction with the following drawings, in which:

FIG. 1 illustrates a prior art implementation of a personal information manager providing secure access to provider information supporting commercial transactions;

FIG. 2 illustrates a prior art database implementation for a personal information manager;

FIG. 3 illustrates an embodiment of the invention presenting a database field outline supporting coordinated notifications;

FIG. 4 illustrates an embodiment of the invention outlining a coordinated notification in respect of an individual loosing their wallet;

FIG. 5 illustrates an embodiment of the invention outlining a coordinated notification in respect of an individual moving house;

FIG. 6 illustrates an embodiment of the invention outlining a coordinated determination of continuation of service in respect of an individual moving house and changing an existing service provider; and,

FIG. 7 illustrates an embodiment of the invention outlining a coordinated notification of modified user details with reduced collection of sensitive personal data.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

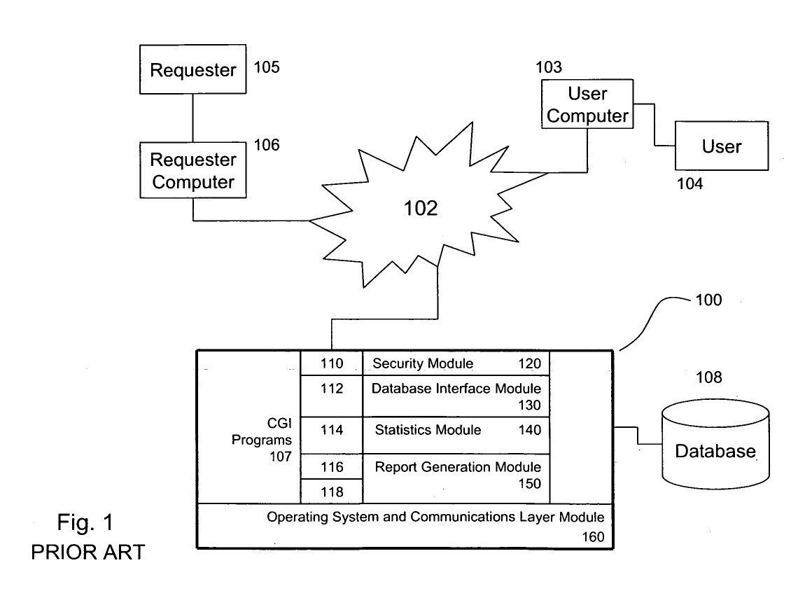

Referring to FIG. 1, shown is a prior art implementation of a personal information manager for supplying secure access to provider information and supporting commercial transactions. The online personal database manager 100 is described in United States Patent Application Publication 2005/0065950. Hence, shown is a user 104 and their user computer 103, which is connected via a network 102 to the user's online personal database manager 100. The online personal database manager 100 provides the necessary management and interfaces for the user in storing and retrieving their personal information from a database 108. Also connected to the network 102 is a requester 105, the requester similarly accessing the online personal database manager 100, thereby retrieving information specific to their service provisions from the database 108, via their requester computer 106.

As shown, the online personal database manager 100 is partitioned into a number of modules, including operating system and communications layer module 160 and Common Gateway Interfaces (CGI) Programs module 107. The CGI Programs module 107 engages user account establishment module 110, user account management module 112, personal information collection module 114, request reception module 116, and authorization verification module 118. Accordingly these modules provide the necessary functions of initially establishing the users' online personal database manager 100, as well as regular management such as billing, backups etc., and receiving and partitioning information with appropriate cross-references provided by the user. Furthermore, these modules provide the protocols in respect of a service provider contacting the online personal database manager 100 and authorizing said requests for release of information.

Additionally, the online personal database manager 100 comprises a security module 120, database interface module 130 that manages the interactions with the database 108, statistics module 140, and report generation module 150. In operation the user 104 engages the online personal database manager 100 via their user computer 103 through the network 102, where on a first-time visit the user account establishment module 110 is activated, allowing the user 104 to establish their account. On subsequent visits the user's 104 user identity and password allow them to enter directly through user account management module 112. Once logged into the online personal database manager 100, the user enters their personal information through the personal information collection module 114, wherein it is stored within the database 108. At a later point in time the requester 105, being one of many service providers to the user 104, submits a request for personal information to the online personal information database 100, this request being processed by the request reception module 116 and authorization verification module 118. Successfully passing the authorization verification module 118 results in the personal information requested by the requester 105 being extracted from the database 108 and provided to the requester computer 106 through the network 102. During these operations the security module 120 ensures that the requester 105 is only provided with the necessary information allowing them to perform the service as required by the user 104.

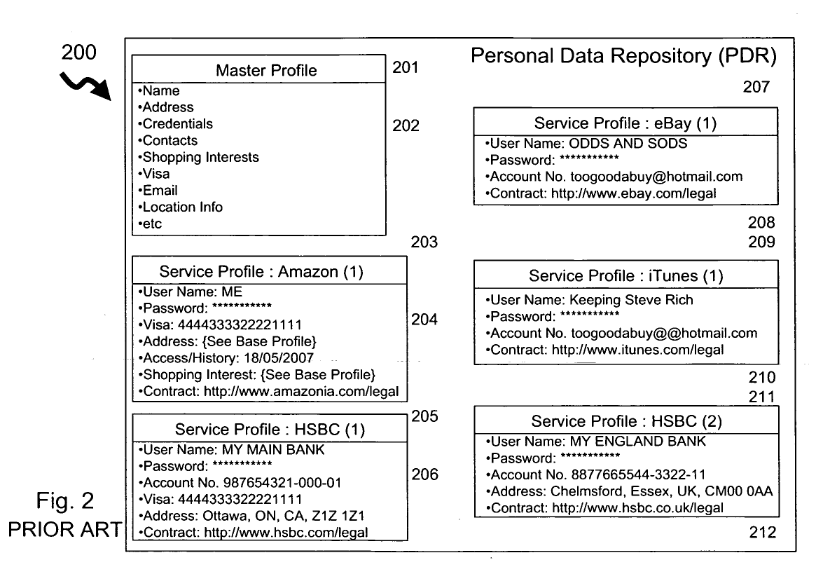

Now referring to FIG. 2, shown is a second prior art approach to an online repository as described in United States Patent Application Publication 2003/0097451, where an essential element is the provision of links to legal agreements made by the user with a plurality of service providers. Shown is the personal data repository (PDR) 200 for a user, which comprises a series of display fields 201 through 212, relating to personal information entered by the user. The first display field 201 provides the user with the title “Master Profile” wherein data within the second display field 202 is associated with all remaining display fields 203 through 212, and referenced directly in some instances. Data within the second display field 202 includes “Name,” “Address,” “Credentials,” “Contacts,” “Shopping Interests,” “Visa,” “E-mail,” and “Location Info.”

The third display field 203 presents “Service Profile: Amazon (1)” allowing the user to see that the information in the fourth display field 204 relates to the service Amazon® and is their first account. The information provided within the fourth display field 204 is “User Name,” “Password,” “Visa,” “Address,” “Access/History,” “Shopping Interest,” and “Contract.” Fifth display field 205 “Service Profile: HSBC(1)” similarly provides the user with the information that sixth display field 206 relates to their first banking account with HSBC, a globally accessible financial institution. As such the data within the sixth display field 206 is “User Name,” “Password,” “Account No.,” “Visa,” “Address” (being the address of their personal branch of HSBC), and “Contract.”

As the user has a second account with HSBC then seventh display field 211 shows “Service Profile: HSBC(2)” wherein (2) denotes their second account. The eighth display field then contains “User Name,” “Password,” “Account No.,” “Address” (being the address 212 of the branch of HSBC within the United Kingdom providing their UK financial activities), and “Contract,” Ninth display field 209 denotes “Service Profile: iTunes(1)” relating to their first online electronic music provider Apple iTunes®, and contains within the tenth display field 210 information relating to “User Name,” “Password,” “Account No.,” and “Contract.”

Eleventh display field 207 relates to another online service provider “Service Profile: eBay(1),” an online auction provider of a wide range of merchandise. Accordingly the twelfth display field 208 provides “User Name,” “Password,” “Account No.,” and “Contract.” It is therefore evident that the PDR 200 addresses the centralized storage of account information for easy recovery by the user, and relates further to contractual information such that in the event of disputes, the user has access to the terms of agreement that was entered into when establishing their accounts.

Neither of the prior art approaches provides the user with a centralized notification or coordination process for making revisions to information that is common to all of, to a significant portion of, or alternatively to some of their service accounts and activities. Additionally, the focus within the PDR 200 and online personal database manager 100 is on electronic service providers. However, many aspects of an individual's personal information have either not been transferred to electronic formats or in some instances relate to services which have minor or zero electronic content. For example, the provision of electricity to the individual only has an electronic aspect if the individual has registered with their electricity supplier; the information they have stored within their online banking for paying electricity bills is not cross-referenced or associated. Equally, a magazine subscription taken out from a mailed-in application form has no electronic information associated with it directly; however, indirectly electronic information is associated with the subscription because the annual subscription renewal is associated with either the user's everyday banking account, for example their checking account, or with their credit card. It would therefore be beneficial to provide an online repository that provided the user with the ability to utilize these links in the event of needing to make changes or adjustments to their personal information, since as is evident from Table 1 there are a very large number of elements of information associated with an individual.

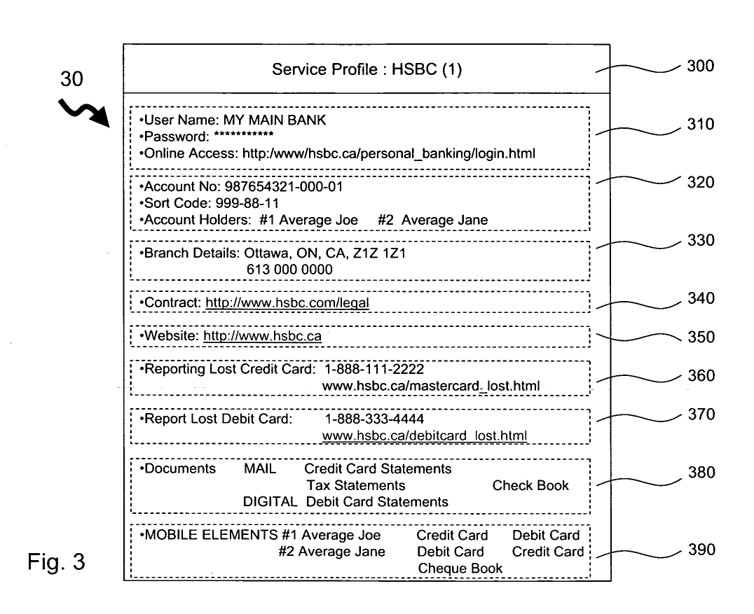

Referring now to FIG. 3, shown is a service profile 30 according to an embodiment of the invention. The service profile 30 is one of a plurality of service profiles stored within a user's online repository, not shown for clarity. The service profile 30 contains a header 300 “Service Profile: HSBC (1)” denoting that the fields relate to the user's first account with HSBC. First data field 310 contains information relating to the user's online account access, namely “User Name” and “Password,” as well as the online access Universal Resource Locator (URL) “http:/www/hsbc.ca/personal_banking/login.html.” Such online access information is important to the user when seeking remote access without having to remember a large number of URLs in addition to their passwords, user names etc.

Second data field 320 provides more specific account information in respect of “HSBC(1)” such as the “Account No.,” “Sort Code” (being the unique identifier of their holding branch), and the names of the account holders, in this case “Average Joe” and “Average Jane,” whereas third data field 330 provides physical location information for the user's holding branch, the branch referenced from their “Sort Code.” Fourth data field 340 provides hyperlink access to contractual agreements and other associated legal documents affecting the service provided by HSBC to the user.

Fifth data field 350 provides a reference to the primary website address of HSBC, which in the instant embodiment presented is “www.hsbc.ca” as the user resides in Canada, and supports access in English, French, and Chinese. Alternatively, for residents of United States, England, Bahrain, India, and Mexico this field optionally stores “www.hsbc.com,” “www.hsbc.co.uk, ” “www.bahrain.hsbc.com,” “www.hsbc.co.in,” and “www.hsbc.com.mx,” respectively.

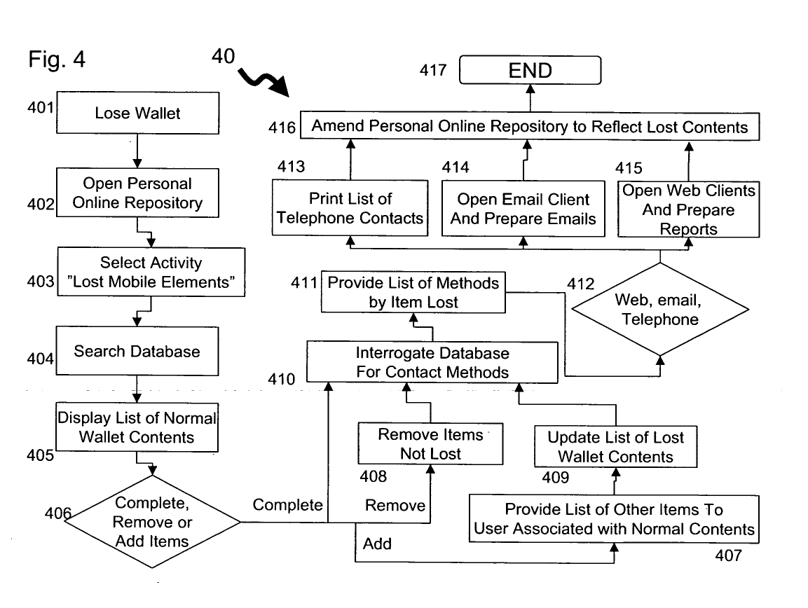

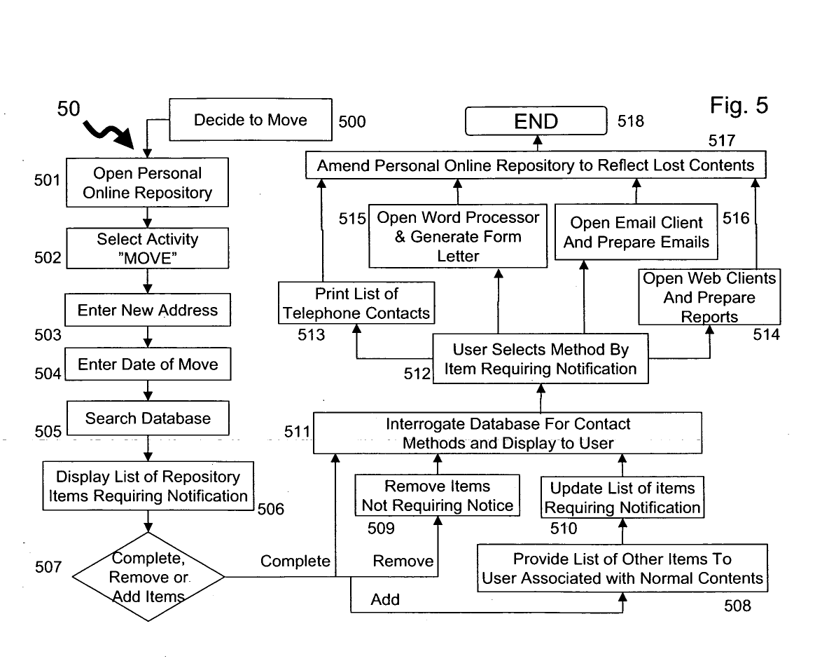

The sixth data field 360 relates to reporting a lost credit card provided by HSBC to the user, the information being both a phone number and a URL. Similarly, seventh data field 370 relates to reporting a lost debit card provided by HSBC to the user, the information being both a phone number and a URL. Such information is important in coordinated notifications for a variety of events, as evident from descriptions in respect of FIGS. 4 and 5 of process flows. Eighth data field 380 provides entries identifying the means by which HSBC provides information. As a result there is a field “MAIL” which lists three documents provided by HSBC to the user by mail, and “DIGITAL” which lists one document provided to the user electronically. As is apparent, the entries within these fields are different for different types of service providers. For example, in the case of the electricity supply provider the user has a quarterly bill under the mail field, and no entry under digital.

Finally, the ninth data field provides a reference to aspects of the user's engagement with the service provider that are “Mobile Elements,” namely elements of their activities with the service provider that are brought with the user in their normal life. Accordingly the ninth data field 390 shows “Average Joe” as having “Credit Card” and “Debit Card,” whilst “Average Jane” has “Debit Card,” “Credit Card” and “Cheque Book.” Such information is important in coordinated notifications for a variety of events, as is evident from the description that is presented with reference to FIG. 4 below, and allows the information within the fields to be personalized to some predetermined degree as necessary to capture the users' interactions with the service provider.

Now referring to FIG. 4, shown is a process flow 40 wherein the user accesses their online repository and exploits the repository's ability to provide coordinated notification. Within this example the user is “Average Joe,” and the first process flow 40 begins with the unfortunate, but not uncommon event of “Average Joe” losing their wallet at 401. Upon establishing that this event has occurred “Average Joe” accesses an electronic device and logs into the online repository at 402. For example, the electronic device is one of a personal computer, a laptop computer, a cellular telephone, a personal data assistant or another electronic device providing Internet, Wireless Access Protocol or cellular access to the online repository.

“Average Joe” then selects their desired activity at 403, which in this instance is entitled “Lost Mobile Elements,” thereby triggering the online repository to perform a search of the database at 404. The search results are then provided to “Average Joe” at 405 as a list of his normal mobile elements. As a result, in the case of “Average Joe” having an account with HSBC as indicated in service profile 30 of FIG. 3, such mobile elements are presented as “HSBC(1) Debit Card” and “HSBC(1) Credit Card.” In some instances the mobile elements associated with one user, “Average Jane,” are items belonging to another user, for example “Average Teenager,” as her daughter's library card and health card are kept in her purse. Here, a particular benefit of coordinated notification is evident, namely that items belonging to a plurality of users are associated such that an event, for example losing a wallet, singularly reported into the online repository, retrieves the fact that the wallet normally contains documents for one, two, or more individuals.

At 406 “Average Joe” is queried as to whether the displayed list of contents is correct or requires additions and deletions. In the event that the user indicates the contents are complete the process moves directly to 410 and interrogates the database for means of notifying the service providers related to items lost within the wallet. If, however, the user indicates items should be removed then the process moves forward to 408 and “Average Joe” removes items, such as for example his credit card that was in his other pocket at the time the wallet was taken by a pick pocket. From 408 the process then moves forward to 410.

Alternatively, if “Average Joe” denotes that the list is incomplete, the process moves to 407 wherein a list of other items is presented to the user. The list comprises, for example, items associated with the normal contents of “Average Joe's” wallet such as other bank cards, driving licenses, and health insurance cards of the family. At 409 “Average Joe” updates the list of contents and the process similarly moves to 410. At 410 for each item identified as lost the database is interrogated and the contact methods retrieved for each service provider related to those items. In some cases two or more methods exist, such as in the case of “Average Joe's” credit card, which as evidenced from the service profile 30 in sixth data field 360 contains a telephone number and URL for notifying the loss of a credit card.

At 411 the user is provided with available methods of contacting the service providers, and at 412 the user selects one of multiple methods when an item has a plurality of contact methods. Optionally, a method is automatically selected based on a prioritization of the service, a preference of the user, or a prioritization of the database system. Other items with a single mode of contact are automatically selected according to that mode. Optionally, the mode of contact is varied according to circumstances, such as the location and/or time of the wallet being lost. Consider the case of the loss of a debit card at 9 am on a Monday morning in New York, then the immediate notification of a lost debit card is important to avoid financial loss to “Average Joe,” whereas reporting the loss of a health card whilst vacationing in Jamaica is often less time critical. Potentially, when a card is lost at 9 am in other time zone then overlap with office hours at a user's place of residence for telephone based notification is smaller or inconvenient compared to an electronic mail notification.

Based upon the selected notification method the process moves from 412 to at least one of 413 through 415 addressing alternate modes of notification. First considering telephone notification, the process at 413 provides “Average Joe” with a consolidated list of service providers and contact telephone numbers to print and utilize, at which point the process moves forward to 416 and makes any necessary amendments to the online registry, such as flagging lost contents, or deleting entries since credit cards reported as lost will be cancelled and replaced with new cards with new serial numbers. Alternatively, the process generates automatically calls each number and provides a message relating to the reported loss. For example, for a credit card, there is often a key sequence to indicate a card as lost or stolen. Thus, entering the key sequence results in the report being entered automatically without further user intervention. Typically, this is achieved based on a priori information of said key sequence.

If electronic mail (e-mail) was selected then the process at 414 opens an e-mail client and prepares an e-mail message for each item to the cross-referenced e-mail address associated with that item. These e-mail messages are then sent to the service providers, at which point the process moves forward to 416. Alternatively, at 415 the notification has been selected as web notification, so for each item the process accesses an appropriate web notification URL, completes the entries required, sends the completed web client notification, and then proceeds to 416. Typically, this is achieved based on a priori information of said required entries.

Optionally, the web client process 415 extracts a stored completed web client page or other formatted document allowing the process to execute in the event of a change in valid URL or a lack of service to specific URL. Such pre-completed web client entries are generated for example at the point of entry into the online repository of the item and associated notification URL. From 416 the process then progresses to completion at 417.

Referring now to FIG. 5, shown is a second process flow 50 according to another embodiment wherein the user accesses their online repository and exploits the repository's ability to provide coordinated notification. Within this example the user is again “Average Joe,” and the first process flow 50 begins at 500 with the decision for “Average Joe,” his wife “Average Jane,” and their daughter “Average Teenager” to move. Whilst such events do not generally necessitate such time sensitive notifications as those in respect of the process for a lost wallet in the first process flow 40 of FIG. 4, such an event impacts, typically, a significantly larger extent of the user's service providers, and hence involves more entries within the online repository than other events, such as for example losing a wallet or purse. In fact, in some instances every service provider is impacted during a move.

Upon deciding to move, “Average Joe” accesses a computer, for example his own, a computer at work, or a computer within an Internet cafe or a library, and logs into the online repository at 501. “Average Joe” then selects the desired activity at 502, which in this instance is entitled “MOVE,” thereby triggering the online repository to request that the user enter a new address at 503 and the date that the new address becomes effective at 504.

The process then performs a search of the database at 505 to identify all aspects of the personal online repository that are affected by the address change, and displays these to “Average Joe” at 506. The display is listed, for instance, one of alphabetically, by sector, or by one of a plurality of other metrics according to a preference of “Average Joe.” At 507 “Average Joe” is prompted as to whether the displayed list of contents is correct or requires additions and/or deletions. In the event the user indicates the contents are complete the process moves directly to 511 and interrogates the database for methods of notifying the service providers related to items identified as address-related, and accordingly impacted by the move.

Of course, not all entries within the online personal repository have reference to the home address of “Average Joe,” for example “iTunes(1)” of FIG. 3 is a purely online account in respect of the purchase and downloading of audio-visual content. As such the “iTunes(1)” references within the online repository do not refer directly to the user's address but instead refer to the HSBC account, which provides the MasterCard information providing the financial resources. If, however, the user indicates items should be removed, then the process moves forward to 509 and “Average Joe” removes items, such as for example reference to the Land Rover Discovery he purchased five years ago and sold last year, but had never updated his online registry in this respect. From 509 the process then moves forward to 510.

Alternatively, when “Average Joe” denotes that the list is incomplete, the process moves to 508 wherein a list of other items is presented to the user. Optionally this list is provided as a series of prompts to “Average Joe” which are constructed by the process correlating the entries within the repository contents; for example the process notes that there are health card entries for “Average Joe,” “Average Jane,” and “Average Teenager” but there is no health card entry for “Average Baby” who is listed in the “Doctor” section of the repository. Alternatively, the prompts come from a standard template. It would be evident to one skilled in the art that such simple omissions often occur when individuals are maintaining their personal information, due to the many factors influencing and affecting everyday lives. At 510 “Average Joe” provides an update to the list of contents, either by selecting fields from the list provided by the process or by entering information in other entry fields, and the process similarly moves to 511. At 511 for each item affected by the address change the database is interrogated and the contact methods for each service provider, as relating to these items, are retrieved and provided to “Average Joe.” In some cases, two or more methods may exist, such as for example “HSBC(1)” 300 of FIG. 3 where the third data field 330 contains an address and a telephone number.

At 512 “Average Joe” selects one of the multiple methods when an item has a plurality of contact methods. Other items with a single mode of contact are automatically selected according to that mode. Of course, the mode of contact may be varied according to circumstances, such as for instance time interval between “Average Joe” entering the information into the online repository and the intended date that the address change becomes active, or the period of notice that is required by the service provider in respect of performing the necessary adjustments to the services provided to “Average Joe.” Optionally, this information is provided by “Average Joe” when generating the entry initially into the online repository, or it is dynamically extracted by performing a search of the websites of the service providers as indicated within the online repository, such as within “Website” 350 of FIG. 3.

Based upon the selected notification method the process moves from 512 to at least one of the steps 513 through 516 addressing alternate modes of notification. First considering telephone notification the process at 513 provides “Average Joe” with a consolidated list of service providers and contact telephone numbers to print and utilize, at which point the process moves forward to 517 and makes any necessary amendments to the online registry. If “letter” was selected then the process moves to 515, wherein the process opens a word processing package and generates a form letter to the service providers for whom the selected mode of notification is “letter,” and then moves forward to 517. The process ends at 518.

If, electronic mail (e-mail) was selected then the process at 516 opens an e-mail client and for each item prepares an e-mail to the cross-referenced e-mail address associated with that item. These e-mails are then sent to the service providers, at which point the process moves forward to 517. Alternatively, at 514 the notification has been selected as web notification, so for each item the process accesses the appropriate web notification URL, completes the entries required, sends the complete web client notification and proceeds to 517. Typically, this is achieved based on a priori information of said required entries.

Optionally, the web client process 514 extracts a stored completed web client page or other formatted document, allowing the process to execute in the event of a change in valid URL, lack of service to specific URL etc. Such pre-completed web client entries may be generated for example at the point of entry into the online repository of the item and associated notification URL.

The provision of coordinated notifications according to second process flow 50 for moving house also notifies the service provider of the intended date of a move, the existing address to which the service is to be terminated, and the new address to which the service is to be continued from. Alternatively, the process is executed automatically at a date proximate the move when early notification is other than supported.

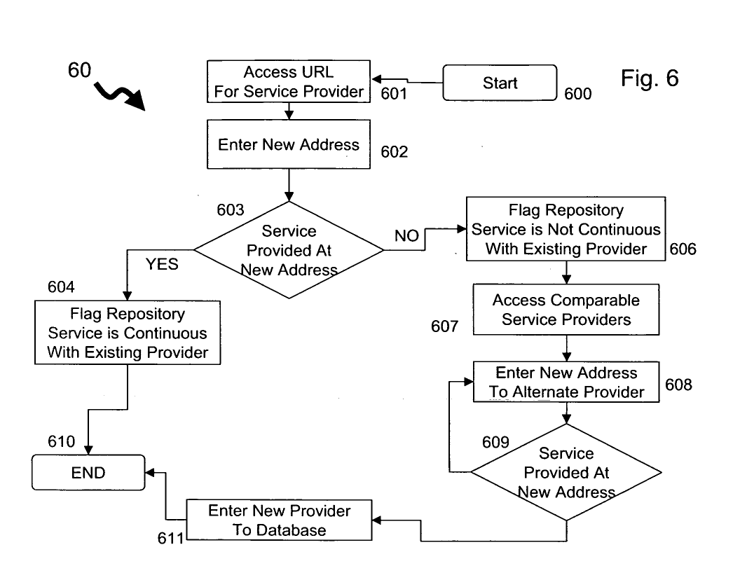

In many instances “Average Joe” does not know whether the current service provider provides the service at the new location. Lack of continuation of the service requires that the notification either be a simple termination notice or a query about who the new service provider will be. A third process, a service continuation flow 60, is shown in FIG. 6, and is a portion of a coordinated notification process such as second process flow 50. Service continuation flow 60 performs automated polling of existing service providers to determine continuation of service at the new address. The process begins at 600 as part of a coordinated notification process, such as “Interrogate Database for Contact Methods and Display to User” 511 of the second process flow 50. At 601 the URL of an existing service provider, for whom details are extracted from the database as part of a coordinated notification system, is accessed. At 602 the new address is entered into the URL resulting in a response from the URL as to whether service is provided by the existing service provider at the new address.

At 603 the service continuation flow 60 determines the actions to perform in response to the information supplied by the service provider in response to the query involving the intended service address. If the response indicates that the current service provider does provide service at the new address, then the process moves to 604 and makes a flag entry within the online repository database to indicate continuation of service. This flagged entry subsequently is utilized at one or more of the steps 513 through 516 of second process 50, to adjust the notification to the service provider. From 604 the process moves to 610 and ends.

If the determination of continued service with the current service provider at 603 is that service is not provided at the new address, then the process moves to 606 and enters an alternate flag entry indicating that the service providers' service is to be terminated at the date of moving. Moving forward to 607 the service continuation flow 60 extracts a list of alternate service providers. For example if “Average Joe” is moving from Ottawa, Ontario, Canada to Picton, Ontario, Canada he would terminate the service provision of his current cable provider, Rogers™. There currently are 26 cable providers within Canada, one of whom may provide coverage in Picton. The service continuation process 60 moves forward to 608, enters the new address into the URL associated with the first alternate service provider (for instance Shaw Cable), and retrieves a result.

At 609 it is determined whether the result is a provision of service or not. If not, the process loops back to 608 and enters the address into another service provider URL. If the service is provided by the specified provider at the new address then the process moves to 611 and the new service provider is entered into the online repository database, and then progresses to 610 and stops. Accordingly, the new service provider information is utilized in one or more of the steps 513 through 516 of second process 50 to provide initial notification to the new service provider that “Average Joe” is moving to Picton, Ontario, Canada.

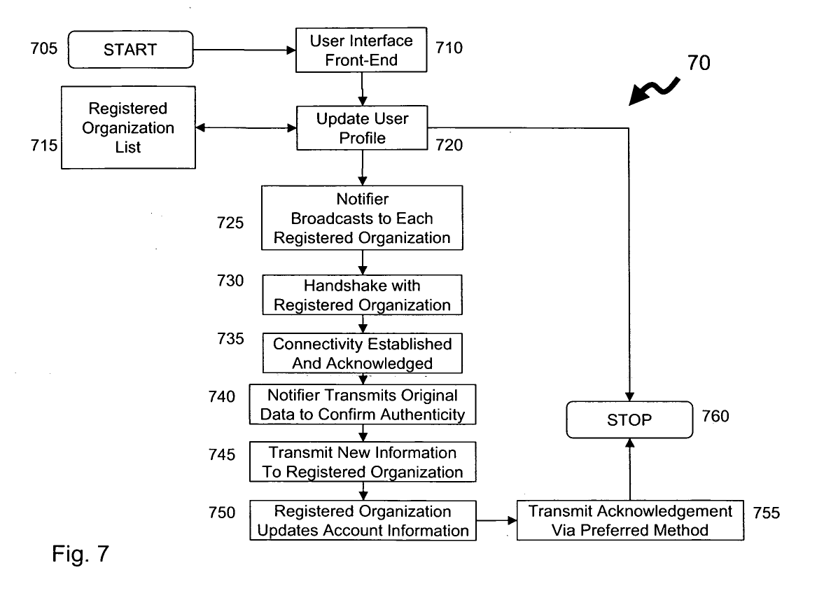

In the embodiments described above with reference to FIGS. 3 through 5, in some circumstances an individual may consider the amount of personal information divulged to be too much for their comfort, at least until they have become confident in the level of privacy afforded their data and that the security systems of the coordinated notification are beyond dispute. Accordingly, an initial user interface with minimal provision of sensitive personal data is optionally presented to new users. Such an initial user interface and coordinated notification are presented in respect of notification flow 70 in FIG. 7.

At 705 the user creates their user profile, which uniquely identifies the end-user with a minimal set of information. For example the user profile simply comprises a home address, home phone number, account number, user logon name as defined by the user, and the user password, also defined by the user. Subsequently, the user accesses the coordinated notification system through the user interface front-end at 710, and the flow then moves to 720, wherein the user makes an adjustment to their user profile. This adjustment is, for instance, the addition of a new organization with which the user has an agreement, in which case the registered organization list 716 is updated. Alternatively it is an adjustment in their personal data such as home address change, wherein the user is prompted to provide an effective date for the change.

In the event that the adjustment is the addition of one or more new organizations, then the process flow moves from 720 to end at 760. If the adjustment relates to profile data of the user and affects the records with the registered organizations, then the coordinated notification system moves to 725 and broadcasts the modified profile data to all registered organizations stored within the registered organization list. At 730 a handshake is performed between the coordinated notification system and a registered organization, wherein at 735 connectivity is established and acknowledged. Now at 740 the coordinated notification system transmits the original user profile information to confirm the user authenticity and account numbers.

With the execution of 740 the user is authenticated with the registered organization and at 745 the new user profile information is transferred to the registered organization and is updated into their records at 750. The notification flow 70 then moves to 755, wherein the registered organization transmits an acknowledgement to the user via a preferred method as defined by the user, which is for example an e-mail, fax, voicemail to home, voicemail to cellular telephone, or a short message service (SMS). The notification flow 70 then moves to 760 and stops.

Step 755 results in the user being informed of any changes that are made to their profile at the registered organization. This step both mitigates the scenario of the coordinated notification system being compromised, as the user is notified of a change by another notification method, and provides confirmation to the user that the changes have been made with that registered organization.

The embodiments of the coordinated notification system as described with reference to FIGS. 3 through 7 are implementable in a variety of optional configurations. One such configuration is a hosted service with multiple servers and back-up servers distributed geographically in order to provide very high uptime, for example 5-nines (99.999%) uptime meaning less than a second of inaccessibility per year, and supporting 24/7/365 coverage.

The use of geographically distributed servers also helps to ensure compliance with various federal/national privacy laws, which typically dictate that personal information must not cross international borders. Thus the hosted services and supporting infrastructure are likely to be within the borders of each country, but agreements may provide for continental or global hosted services. Optionally future non-sensitive personal information maybe pre-populated by the service provider and simply requires end-user to acknowledge. For example, a magazine subscription which may constitute an account number for the subscription and the address of the user. Once a user subscribes then they are e-mailed an e-mail notification with an embedded URL to direct the user to the service provider site with pre-populated fields and end-user is authenticated, e.g. password e-mailed in a separate e-mail address.

Typically each time the user authenticates themselves their end-user profile is updated and stored in a repository. Such storage of information is non-critical, which means financial, banking, investment, and other sensitive information such as Social Insurance Number (SIN) are not stored in repository, unless such repository has sufficient safe-guards and encryption where banking and other financial and government bodies are comfortable such measures meet their requirements for security.

The repository typically employs encryption for all information, sensitive or otherwise, such that if storage media is lost or compromised such data is not released and in the ‘clear’. These encryption algorithm and keys should be of sufficient strength to safeguard the repository against unauthorized access.

The embodiments described with reference to FIGS. 3 through 7, are described primarily in respect to typical utilities and services for an individual. Of course, optionally the coordinated notification system is extended to cover the interfacing and notifying in other instances, such as business-to-business (B2B), business-to-government (B2G), and consumer-to-government (C2G). In such instances, businesses when moving from one office location to another update their address of business to all government institution databases e.g. Canada Revenue Agency for federal taxes, provincial ministry of finance for state/provincial taxes, etc. Consumer updates, e.g. address change, would be reflected in government databases in a manner similar to that which was described above with reference to FIG. 5.

In addition to the notification of changes in respect of the user profile, the coordinated notification system as discussed with reference to FIGS. 3 through 7 can accommodate and provide additional services to the user. Such services for example could include:
(1) Authorized payment to a subscription or professional memberships on regular basis, e.g. annual renewal;
(2) Flag user of upcoming renewal dates of such memberships, subscriptions, etc.;
(3) Set a maximum ceiling for payment of such fees to ensure safeguards against fraud;
(4) Cancellation notices to service providers—subscriptions, memberships, utility services upon renewal dates or when user relocates; and
(5) accommodate fields be pre-populated from service provider database through programming interface (API).

In some embodiments of the invention, the descriptions include the physical printing of service providers and their phone numbers as part of utilizing the coordinated notification, which in many instances would entail a lengthy process and going through several automatic attendants/electronic attendants. Such a process may be very time consuming in a time sensitive issue such as when a user has lost their wallet. Accordingly the coordinated notification system may optionally allow the user to bypass this process and simplify the list of registered organizations to contact.

In such instances the user through Internet access, WAP or telephone once they have entered their user logon name and user password can access the coordinated notification system and through a Graphical User Interface (GUI) or touch-tones, navigate to one of several predetermination actions. For example, a single short cut entered into the coordinated notification system selects “lost wallet” and notifies all service providers contained in the wallet—store cards, bank cards, credit cards, Health Card, Drivers license etc to perform specific actions selected in a second menu, such actions for example including:
a. Shutdown use of such services, e.g. credit cards
b. Place a hold on such services—e.g. 30 days to allow the user to find their misplaced wallet).
c. Shutdown and request replacement of such services with authorized-billing where applicable, e.g. drivers license replacement fee.

Optionally, the coordinated notification system encompasses electronic mail directories similar to those currently published for telephone numbers and addresses, such as the white and yellow pages. In such electronic mail directories the user is able to rapidly search and add the notification e-mail addresses of organizations they wish to include within the registered organizations. At present such information can be very difficult to find and may be incorrect.

Numerous other embodiments may be envisaged without departing from the spirit or scope of the invention.

What is claimed is:

1. A method comprising:
storing a plurality of service profiles in a network-accessible repository, each profile of the plurality of service profiles including data relating to a service, a user, and data relating to identifying the user by said provider of the service;
receiving via the network a notification request relating to a change of status of a first user;
determining a subset of the plurality of service profiles, each profile of the subset of profiles comprising data that are affected by the change of status of the first user; and,
extracting, based on each profile of the subset of profiles, contact data defining at least a mode of delivery for providing a notification message to a service provider that is associated with that profile and address information for directing delivery of the notification message to the service provider via the mode of delivery.

2. A method according to claim 1, wherein the subset of profiles defines a coordinated notification group including at least two different service providers, and comprising for each one of the at least two different service providers:
providing automatically a notification message based on the contact data extracted based on a corresponding profile of the subset of profiles, the notification message relating to the change of status of the first user.

3. A method according to claim 1, wherein the subset of profiles defines a coordinated notification group including at least two different service providers, and comprising for each one of the at least two different service providers:
providing to the first user, in a human intelligible form, information based on the contact data extracted based on a corresponding profile of the subset of profiles.

4. A method according to claim 1, wherein the subset of profiles defines a coordinated notification group including at least two different service providers, and comprising: for one of the at least two different service providers providing automatically a notification message based on the contact data extracted based on a corresponding profile of the subset of profiles, the notification message relating to the change of status of the first user; and,
for another one of the at least two different service providers providing to the first user, in a human intelligible form, information based on the contact data extracted based on a corresponding profile of the subset of profiles.

5. A method according to claim 1, wherein the subset of profiles defines a coordinated notification group including at least two different service providers, and comprising providing automatically a notification message to each one of the at least two different service providers in dependence upon extracted contact data relating thereto, each notification message relating to the change of status of the first user.

6. A method according to claim 1, wherein the change of status of the first user relates to an event occurring prior to receiving the notification request.

7. A method according to claim 6, wherein the change of status of the first user relates to loss of at least one of a credit card, a debit card, a benefit access document and an identity document associated with the first user.

8. A method according to claim 1, wherein the change of status of the first user relates to an event that is scheduled to occur subsequent to receiving the notification request.

9. A method according to claim 8, wherein the notification request includes new data that is valid for the first user after the change of status, and an indication of a time from which the new data is valid.

10. A method according to claim 1, wherein the mode of delivery is selected from the group consisting of: electronic mail delivery, postal service delivery, short message service delivery, telephonic delivery and delivery via a fillable-form of a World Wide Web page.

11. A method according to claim 1, wherein the change of status of the first user relates to a change of contact information for the first user.

12. A method comprising:
storing a plurality of service profiles in a network-accessible repository, each profile of the plurality of service profiles including data relating to a service, a user, and data relating to identifying the user by said provider of the service;
receiving via the network an indication relating to a change of status of a first user and including data for identifying service profiles comprising data that are affected by the change of status of the first user;
based on the data included with the indication, identifying a plurality of service profiles containing data that are affected by the change of status of the first user, including a first profile that is associated with a first service provider and a second profile that is associated with a second service provider; and,
extracting, based on the first and second service profiles, contact data for use in providing notification messages to the first service provider and to the second service provider, respectively, the notification messages relating to the change of status of the first user.

13. A method according to claim 12, wherein the contact data extracted based on the first service profile defines a mode of delivery for providing a notification message to the first service provider and address information for directing delivery of the notification message to the first service provider, and wherein the contact data extracted based on the second service profile defines a mode of delivery for providing a notification message to the second service provider and address information for directing delivery of the notification message to the second service provider.

14. A method according to claim 13, comprising for each one of the first and second service providers, doing one of:
providing automatically a notification message in dependence upon the corresponding extracted contact data; and,
providing to the first user, in a human intelligible form, information based on the corresponding extracted contact data.

15. A method according to claim 13, comprising providing automatically a notification message to the first service provider in dependence upon contact data extracted based on the first service profile and providing automatically a notification message to the second service provider in dependence upon contact data extracted based on the second service profile.

16. A method according to claim 12, wherein the change of status of the first user relates to an event occurring prior to receiving the indication.

17. A method according to claim 12, wherein the change of status of the first user relates to an event that is scheduled to occur subsequent to receiving the indication.

18. A method according to claim 17, wherein the notification request includes new data that is valid for the first user after the change of status, and an indication of a time from which the new data is valid.

19. A system comprising:
a storage medium for retrievably storing a plurality of service profiles, each profile of the plurality of service profiles including data relating to a service, a user, and data relating to identifying the user by said provider of the service; and,
a user interface, implemented in software that is installed on an electronic device, in network communication with the storage medium, for receiving an indication relating to a change of status of a first user, and for identifying at least two service profiles of the plurality of service profiles that contain data that is affected by the change of status of the first user, and for coordinating notification activities for notifying at least two different service providers that data contained in a service profile relating thereto is affected by the change of status of the first user.
